(19) United States
(12) Patent Application Publication
(10) Pub. No.: US 2013/0117081 A1
(43) Pub. Date: May 9, 2013

(54) Lead Fraud Detection

(71) Applicants: Jeffrey K. Wilkins, Boulder, CO (US); Prashant P. Devdhar, Cupertino, CA (US); Ian J. Wilkins, Boulder, CO (US)

(72) Inventors: Jeffrey K. Wilkins, Boulder, CO (US); Prashant P. Devdhar, Cupertino, CA (US); Ian J. Wilkins, Boulder, CO (US)

(73) Assignee: FAIR ISAAC CORPORATION, Minneapolis, MN (US)

(21) Appl. No.: 13/588,900

(22) Filed: Aug. 17, 2012

Related U.S. Application Data
(60) Provisional application No. 61/556,473, filed on Nov. 7, 2011.

(51) Int. Cl. G06Q 30/02

(52) U.S. Cl. 705/14.4

(57) ABSTRACT

Data is received that characterizes one or more leads. Thereafter, it is determined, for each of the one or more leads, whether the lead is likely to be fraudulent and/or inaccurate using at least one predictive model. In some implementations, one or more of the utilized predictive models can be trained using a plurality of historical leads with known fraud or accuracy data. Data can be later provided that identifies and/or includes one or more of (i) those leads that are determined to be fraudulent and/or inaccurate and (ii) those leads that are determined not to be fraudulent and/or inaccurate. Related apparatus, systems, techniques and articles are also described.

### RELATED APPLICATION

This application claims priority to U.S. Pat. App. Ser. No. 61/556,473 filed on Nov. 7, 2011, the contents of which are hereby fully incorporated by reference.

### TECHNICAL FIELD

The subject matter described herein relates to detection of fraudulent and/or inaccurate leads.

### BACKGROUND

Online advertising has become an integral part of the sales and marketing efforts of businesses. Online advertising can be classified based on its objective into either branding or direct response. In some cases, the goal of direct response advertising is not e-commerce, but rather identifying consumers with an interest in, or affinity for, a product or service. This process is called lead generation. In some cases, a basic lead may comprise a name, contact information, a source Universal Resource Locator (URL) where the lead was collected, an Internet Protocol (IP) address of the consumer's device used to submit the lead and a time/date stamp specifying when the lead was collected. In other cases, consumer answers to additional advertiser-supplied questions may be collected and included in a lead generation process.

Lead generation is becoming increasingly distributed with leads being generated by proprietors operating numerous websites across the globe. However, leads generated from such disparate sources have been plagued by poor data quality and fraud. Similar problems have plagued user registrations on websites.

### SUMMARY

In one aspect, data is received that characterizes one or more leads. Thereafter, it is determined, for each of the one or more leads, whether the lead is likely to be fraudulent and/or inaccurate using at least one predictive model. In some implementations, one or more of the utilized predictive models can be trained using a plurality of historical leads with known fraud or accuracy data. Data can later be provided that identifies and/or includes one or more of (i) those leads that are determined to be fraudulent and/or inaccurate and (ii) those leads that are determined not to be fraudulent and/or inaccurate.

The providing data can include one or more of storing data, loading data, displaying data, and transmitting data. The provided data can, in some cases, be provided in real-time to give immediate feedback to a user/marketer. The predictive model can be used to generate a score for each lead such that scores not meeting a pre-determined threshold or thresholds are determined to be likely fraudulent or inaccurate.

The leads can comprise web-generated leads and/or data derived from non-web generated leads. The web-generated leads comprise user-generated subscriptions or account registrations on a website. The web-generated leads can include user-generated requests for products and/or services.

At least one lead can be pre-processed based on one or more pre-defined attributes of such at least one lead. The pre-processing can be used to exclude leads or lead sources prior to analysis using the predictive model (thereby obviating the need to analyze such lead). The pre-processing can also or alternatively be used for other purposes such as standardizing the data for the predictive model and the like. Various types of pre-processing can be performed including, for example, data cleansing, identifying duplicative leads, attempting to verify one or more aspects of the filtered lead, and the like. Leads can also be post-processed after the predictive model analysis to identify certain leads or lead sources that should be excluded from either the fraudulent or the non-fraudulent categorizations.

The received data can include attributes for each lead. The at least one predictive model can assign varying weights to the attributes of the leads. Various types of predictive models can be used including, for example, a scorecard model, a neural network, and a support vector machine.

The predictive model can utilizes fraud indicators that in turn use various attributes associated with the lead. These attributes can include or be based on one or more of: routable Internet Protocol (IP) address, IP address geolocation, network owner of IP address, static IP address, frequency of use of IP address, number of leads corresponding to consumer, lead collection uniform resource locator (URL), dedicated lead provisioning, popularity of a referring URL, time stamp, date stamp, traffic handling capacity, lead source overlap, complaint rates, opt-out rates, change of address, e-mail address construction, presence of specified fields, browser type, highly correlated reference database entries, pixel-tracking results, geographic areas served by a corresponding lead source, census information, a price charged for the lead, and a volume or a change in volume of leads originating from the corresponding lead source.

The provided data can identify a particular lead as being fraudulent and/or inaccurate or a lead source as delivering fraudulent and/or inaccurate leads.

Computer program products are also described that comprise non-transitory computer readable media storing instructions, which when executed by at least one data processor of one or more computing systems, causes the at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many advantages. For example, by earlier identifying fraudulent leads, lead sources, and user registrations, conversion rates relating to such actions can be increased while costs to lead buyers can be decreased (i.e., lead buyers can avoid paying for fraudulent or otherwise poor leads, etc.).

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a method for characterizing leads as likely being fraudulent and/or inaccurate; and

FIG. 2 is a logical diagram illustrating various lead sources.

### DETAILED DESCRIPTION

As used herein the term “lead”, unless otherwise qualified, should be construed as comprising both web or online generated leads (including those generated via registration processes embedded in installed software, “click-to-call” processes, and smart phone apps) as well as leads generated via different offline modalities (including call centers, trade shows, and written consumer submissions, etc.); provided that such leads are ultimately in a digital data format. Web-generated leads can include user-generated submissions for particular products or services and/or they can include user website registrations. For the latter, user website registrations need not necessarily be in conjunction with a particular product or service, but rather can include various types of non e-commerce platforms such as social networking, gaming, and other types of entertainment and educational websites across web and mobile platforms.

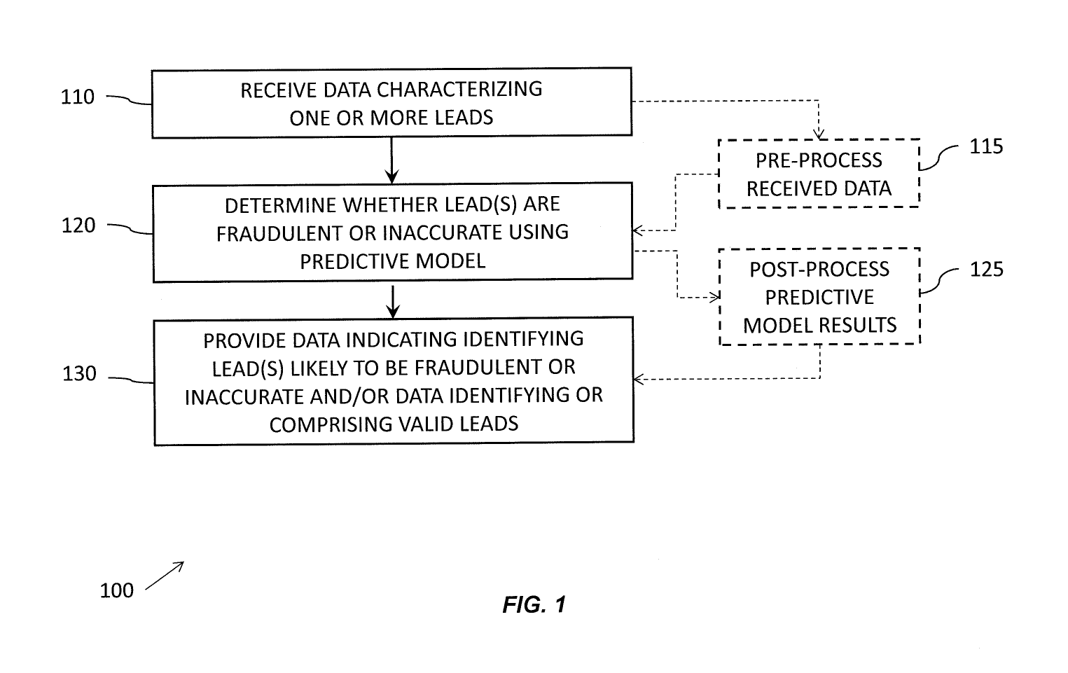

With reference to the process flow diagram 100 of FIG. 1, data is received, at 110, that characterizes one or more leads (and/or lead sources). Thereafter, at 120, it is determined for each lead (and/or lead source) whether the lead (and/or lead source) is likely to be fraudulent and/or inaccurate using at least one predictive model. In one implementation, one or more of the predictive models may be trained using a plurality of historical leads with known fraud or accuracy data. In some implementations, the parameters of the predictive model may be set without training Data is then provided, at 130, that identify those leads (and/or lead sources) that are determined to be fraudulent and/or inaccurate. In some implementations, some or all of the data provided at 110 and 130 may be used in future training or re-training of predictive models. In some implementations, the data is optionally pre-processed prior to the use of the predictive model (i.e., pre-processed at 115) so that certain leads or lead sources are excluded from analysis and/or the results of the predictive model can be post-processed (i.e., post-processed at 125) so that certain categorized leads or lead sources can be excluded in some fashion. The pre-processing can additionally or alternatively be used for purposes such as data cleaning, verification and the like to, for example, standardize the data format for use by the predictive model. One example is address processing (CASS, DPV, NCOA), which may correct a lead/standardize its format without excluding it.

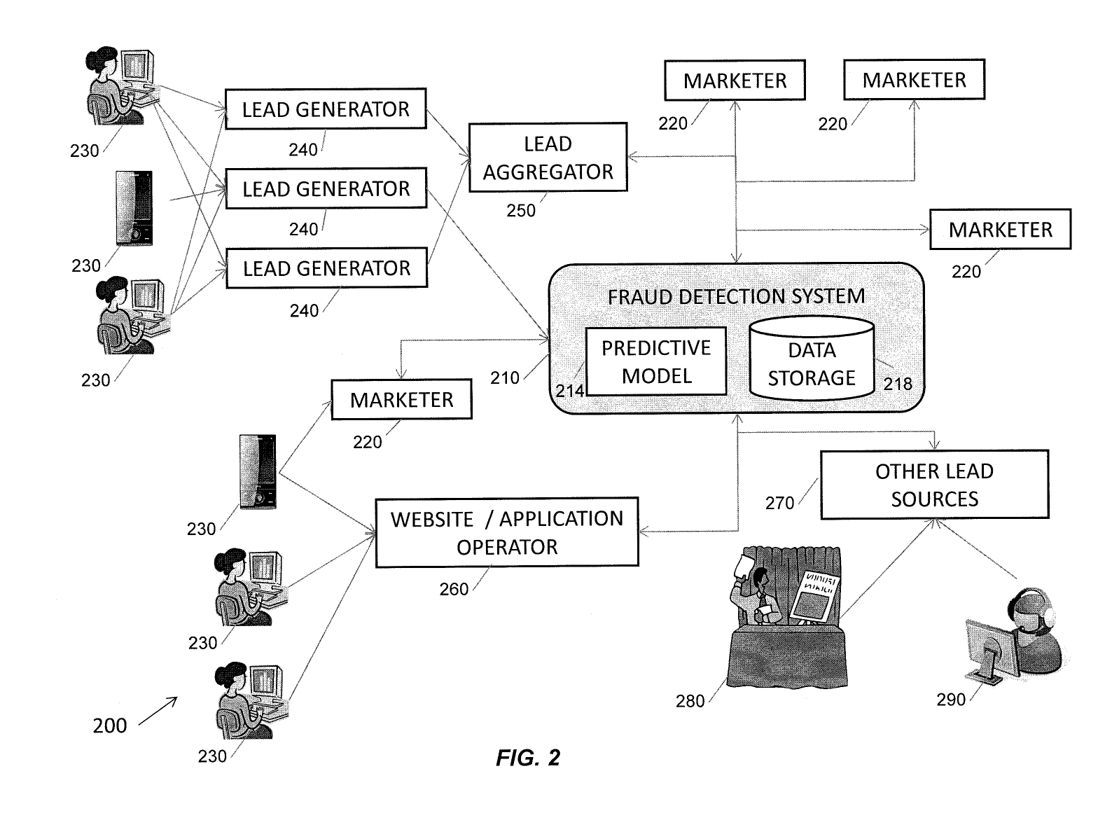

FIG. 2 is a diagram 200 illustrating a sample ecosystem that includes a fraud detection system 210 that makes determinations on whether various leads are likely to be fraudulent and/or inaccurate on behalf of marketers 220 (i.e., entities consuming or otherwise using leads, etc). The fraud detection system can include a predictive model module 214 that takes data characterizing leads and makes determinations regarding same (e.g., scores indicating a likelihood of fraud, etc.) and data storage 218 that can store data characterizing leads and/or data characterizing determinations made by the predictive model module 214. Leads can be generated from a variety of sources and delivered to the fraud detection system 210 by a variety of delivery means. For example, lead generators 240 may operate various outlets (e.g., websites, mobile applications, etc.) that obtain lead information from a plurality of users 230 via one or more communications networks. In some cases, the lead generators 240 can be directly coupled to the fraud detection system 210. In other cases, a lead aggregator 250 obtains leads from multiple lead generators 240 and delivers aggregated leads to the fraud detection system. Leads may be delivered to the fraud detection system either one by one, in some cases in real-time, or in batch submissions. In some instances, the system must respond in real-time so that the buyer of the lead can determine whether to accept or reject the lead at the time of delivery. In other cases, a lengthy, more detailed analysis can be conducted of an entire batch of leads. A decision can be made whether to accept or reject the lead source (and all associated leads).

In addition, in some cases, a marketer 220 may solicit leads directly from various users 230. As another example, a website or application operator 260 obtains user registrations from the various users 230. While such user registrations may not be tied to a particular product or service, data characterizing same can be analyzed by the fraud detection system 210 in order to determine their validity. Further, the fraud detection system 210 interface with other lead sources 270 such as trade show leads 280 and call center leads 290; provided that data characterizing such leads is made available (e.g., handwritten leads are converted to electronic format, call center operators enter into lead information into a computer, etc.). In cases in which the leads/user registrations are generated via a computer, the fraud detection system 210 can provide real-time feedback whether such leads/user registrations are likely to be fraudulent. In some cases, the fraud detection system 210 can provide, via an interface at the lead collection source, feedback to a user 230 identifying an entry as being erroneous. Examples can include a mismatch between a city and a ZIP code or a an e-mail address containing an invalid top-level domain.

The received data characterizing the one or more leads can include various attributes which are largely dependent on the type of lead and the lead generation source. For example, lead generation programs are usually priced on a performance basis (e.g., cost-per-action, -lead or -inquiry). Some sample lead generation program use cases include ‘For profit’ Higher Education Institutions and Consumer Packaged Goods (CPG) companies.

‘For profit’ Higher Education Institutions collect higher education leads. A higher education lead often includes a potential student's name, contact information (e.g., a phone number), and custom questions such as highest educational attainment, degree program of interest and best time to call. An associated source URL, IP address, and time/date stamp may also be included in the lead.

CPG companies collect detailed consumer data to better qualify consumers for their customer relationship management strategies. Their strategy is to build a large database of loyal customers and/or drive new product trial(s). For example, a newsletter sign-up, sweepstakes, contest(s), coupon(s), and/or free sample(s) may be offered to a consumer in exchange for sharing their personal information with the CPG marketer.

CPG companies often collect, for each lead, a full name, a postal address, an e-mail address, as well as explicit permission to contact the consumer for ongoing communications. In some cases, IP address, source URL, and time/date stamp are collected. In some instances, additional detailed data can be collected. Examples of detailed data may include: demographics (e.g., gender, age, etc.), life stage (e.g., marital status, number/gender/age of children, etc.), lifestyle (e.g., rent or own home, annual household income, etc.), category consumption (e.g., purchase frequency, etc.), brand loyalty (e.g., competitive purchase history, etc.), and so on.

Below are two techniques that CPG companies commonly utilize to collect information:

Basic Co-registration—Co-registration piggybacks on an existing registration process. Consumers are presented with a simple checkbox sign-up during the registration process to opt-in to receive marketing communications from the CPG company. Upon opt-in, the CPG company receives basic data about the consumer collected during the preceding registration process such as name, postal address, and e-mail address. Marketers use this data to build a database of interested consumers and send periodic newsletters and e-mail communications to them to increase brand awareness and loyalty.

Enhanced Lead Acquisition—A longer, customizable contact form allows CPG companies to receive detailed consumer data and use it to improve their marketing efforts. The form may include questions designed to collect detailed data (e.g., additional contact information, demographics, life stage, lifestyle, category consumption, brand loyalty data, etc.). Marketers may use this data to segment consumers into groups in order to send more relevant, customized future e-mail communications or personalized samples. This data can be collected through enhanced co-registration, or from consumers driven to the form through display advertising, paid or organic search, social media, e-mail marketing or other techniques.

As noted above, in some implementations, the leads can be pre-processed prior to being submitted to the predictive model (at 115) to determine whether they are likely to be fraudulent and/or inaccurate. This processing can sometimes be referred to as data cleansing. The pre-processing 115 can also be used for data cleansing, verification, harmonization and the like for purposes other than lead exclusion/flagging. The results of the predictive model can also be filtered (at 125) to remove fraudulent leads or lead sources in some implementations using similar techniques as to the pre-processing. In another implementation, suspect leads and lead sources may be flagged but still delivered to the lead buyer.

Data cleansing can focus on the name, postal address, telephone number, or e-mail address fields in a lead:

Name. Name fields can be matched against a profanity and bogus name list. This eliminates leads with names like “Mickey Mouse” and assorted expletives.

Postal Address. U.S. records can be subjected to full postal address standardization, validating the address and putting it in a standard format that ensure maximum deliverability and the highest match rates for de-duplication and data append. Postal addresses can be validated and standardized using CASS or DPV processing:

a) Coding Accuracy Support System (CASS). The CASS process can include address standardization of pre/post directionals and abbreviations, ZIP correction, ZIP+4 appending, carrier-route coding, delivery point coding, error message code, and CASS Report. CASS can be used to determine if an address is within a deliverable range of addresses. It does not verify the existence of a particular street address or accompanying apartment or suite number.

b) Delivery Point Validation (DPV). DPV can enable verification that an actual address exists, down to secondary address information such as an apartment or suite number. DPV can also flag those records missing secondary address information.

Telephone Number. Phone numbers are usually standardized in a common 10 digit format. Likely area code will be appended if missing. The area code (NPA) and pre-fix (NXX) combination (first 6 digits of phone number) can then be matched against a telecommunications database containing all valid NPA/NXX combinations in the North American Numbering Plan.

E-mail Address. E-mail addresses can be subjected to a multi-point syntactical check. These tests include minimum length, illegal character, valid TLD, and more. Limited e-mail address correction can also be performed to correct for common keying errors and truncated records. An example would be changing the domain name “aol.com” to “aol.com”.

E-mail transmission validation can also be used. A test e-mail (or initial welcome auto-responder) can be sent and if the e-mail bounces it is rejected. Bounce processing ensures that bounces are identified and expunged before final delivery to the lead buyer. Finally, some Internet Service providers and consumer e-mail services support a variant of “SMTP Verify” to ping a mail server to see if the user account is valid, without transmitting a message to it.

For undeliverable e-mail addresses, optional electronic change of address (ECOA) processing can be performed to append a new, valid address.

Deduplication. In addition to data cleansing, deduplication can also or alternatively be performed to ensure that the leads are unique. The rules for the deduplication vary. In some cases, duplicates can be detected by matching new leads against one or more databases of previously sourced leads. In some instances, duplicates can be detected only within that day's lead stream (i.e., batch of leads within a pre-defined period of time, etc). Deduplication may also apply within a given lead source, or across all vendors.

Data Verification. While data cleansing techniques can improve lead quality, they do not verify that the contact info did in fact belong to the registrant. Data verification can be employed to validate and/or to verify that the registrant actually lives at the supplied postal address, and owns the supplied phone number, and uses the supplied e-mail address. Such data verification can form part of the current platform and/or they can be accessed via various web services offered by third parties.

Fraud Detection/Accuracy Check. While the above cleansing/verification/filtering can help ensure clean leads, they do not prevent lead fraud nor can they identify inaccuracies which are not picked up by the filtering. Lead fraud can occur when a lead supplier fabricates a lead, albeit with valid contact information. For example, a person seeking to profit from fraudulent leads could write a program which randomly extracts valid consumer records from a U.S. consumer database, populates the remaining fields for the lead, and delivers it to a marketer or other lead buyer. In some cases, such actions come directly from a lead generation source while, at other times, such fraudulent activities can occur at different points in the process.

Often lead fraud is detected only after the fact, when a lead is contacted. The leads that are fraudulently obtained will typically exhibit poor response rates and/or higher complaint rates. For telephone or direct mail campaigns, enormous amounts of resources as well as money may be wasted. With e-mails, contacting bogus leads may lead to deliverability problems for all of the marketer's e-mail activity. Such empirical findings can be used to further train the predictive model (as will be described in further detail below).

Online generated leads often include three data fields (in addition to other data fields that characterize the corresponding consumer): time/date stamp, IP address, and URL. The time/date stamp marks the time when the consumer completed the lead form. The IP address corresponds to the consumer's device, used to complete the lead. The URL refers to the web address of the form completed by the consumer. Historically, the purpose of these fields has been to validate, in the event of a complaint, that the consumer “opted-in” to be contacted by the marketer. The fields can provide comfort to the marketer (i.e., the entity consuming the leads, etc.) that the data was legitimately collected.

Each lead comprises various attributes such as the contact information of the person or entity and information identifying the corresponding product or service. These attributes can be used to derive a set of fraud indicators. These fraud indicators can be generated for a given lead source or vendor or they can be used across multiple lead sources/vendors. Optionally, these fraud indicators can be weighted. The weights can reflect an importance and/or influence, perhaps with respect to the given lead source or vendor. An overall fraud score can then be produced from the fraud indicators, for example, by summing the weighted fraud indicators. The fraud score can then be compared with a predetermined threshold to determine whether a lead is considered valid or likely to be fraudulent. These determinations can be used to classify a given lead source or vendor, in aggregate, as valid or fraudulent.

A set of fraud indicators {f₁, f₂, f₃ . . . fₘ} can be assembled for each lead based on the attributes of the received data for each lead. The fraud indicators can, in cases of a scorecard model implementation, be weighted, {w₁, w₂, w₃ . . . wₘ}, and be added to produce an overall fraud score:

Fraud Score=F=Σₙ₌₁^{m}(wₙ fₙ)

In some implementations, a fraud score above a pre-defined threshold can indicate fraud. Such a threshold can be for all leads or it can be based on leads having certain attributes (e.g., time of day, lead generation source, etc.). Other types of predictive models can be utilized including neural networks and support vector machines with the attributes for each lead being used as input to such models (the attributes can be used to populate nodes of such models, etc.).

The fraud indicators and weights can be chosen based on heuristics. For example, consider a fraud indicator based on IP address. A simple fraud binary indicator variable could involve detecting >5% of IP addresses as unroutable. If this is the case, the source is almost surely fraudulent. The weight would be selected so that the fraud score exceeds the threshold irrespective of the other fraud indicators. In some implementations, artificial intelligence techniques may be used to determine the rules. For example, a knowledge engineer may work with a human expert to capture the rules/heuristics they use in assessing lead fraud. The rules may then be embedded in an expert system and used to classify the leads and lead sources.

In some implementations, advanced statistical techniques such as logistic regression models, neural networks, support vector machines or other machine learning techniques can be used to discover the optimal classification formula. In this case, the models or neural network can be developed or trained using sets of lead data deemed to be valid and deemed to be fraudulent (i.e., historical leads with known outcomes and/or an empirically derived data set, etc.).When a lead source is classified as fraudulent, the marketer may wish to expunge the lead source from the database and suspend new lead acquisition from the lead source. Such expunging/suspending can form part of the pre-filtering 115 and/or the post-filtering 125.

In some variations, individual records within a lead source can be classified as fraudulent or valid. In the case of single record submissions, such submissions can be analyzed in real-time (i.e., as of the time of submission, etc.) to determine whether the submission is fraudulent and/or inaccurate. In the case of batch file submissions (such as a day's worth of leads), the marketer can determine whether the leads, in batch, are individually fraudulent and/or inaccurate. The marketer may choose to get credit for individual leads that fail validation or all leads associated with a questionable lead source.

The fraud indicator variables can include or be based on one or more of the areas listed below. In addition, it will be appreciated that such variables can be used, in some cases, for the pre-filtering 115 and/or the post-filtering 125.

Routable IP Addresses. In a typical lead fraud situation, the IP addresses are fabricated. Every device on the Internet has a unique ID number, called an IP Address. The current standard, IPv4, is comprised of 32 bit addresses for a theoretical maximum of about 4.3 billion addresses. Currently, about 3 billion addresses are in use. These addresses are “assigned” or “allocated” and routable. Ideally, there should only be Allocated and Assigned IP addresses in a file. ‘Allocated’ means that the IP address or IP block has been issued to an ISP or large corporation for usage. ‘Assigned’ means that the ISP in turn directly assigned the IP addresses or IP blocks to a large customer. The other status types: Bogus, reserved, unallocated, and unknown, are all IP Status types that are highly suspect. These are unroutable IP addresses not assigned to an end user. Based on the fraction of routeable IPs numbers above, in a fraud case where IP addresses are randomly assigned, upwards of 25% of the IPs would likely be unroutable. Since the IP assignments are constantly evolving, care must be taken to match the IP allocations based on the date of opt-in.

IP Geolocation. Routability checks by itself may not detect all fraud. It is possible that a rogue lead supplier may have access to a routable IP table. If so, it is straightforward to select IP addresses that look legitimate. In many instances, IP addresses correspond to physical locations. By comparing the consumer's supplied postal address (and city/MSA/zip code) against the geolocation of the IP, it is also possible to detect fraud. However, there are legitimate cases where the consumer supplied physical address and IP geolocation will not match. For example, a consumer who completes a lead form while traveling may not match. In other cases, IP addresses may correspond to proxy servers in a distant location and not the consumer's home address. Thus, one variation considers the overall match rate on a statistically significant sample. If the overall rate falls below a pre-defined threshold, it can indicate that the lead source at issue is fraudulent.

Network Owners. In some cases, a preponderance of IP addresses within a given network address block owned by the same network owner may indicate fraud. Comparing expected frequencies against actual frequencies may identify differences indicative of fraud. For example, a fraudulent lead source might have a disproportionate number of consumer leads from a top-level domain, for example .org, .cn (for US leads). Fraud might also be indicated if a disproportionate number of consumer leads come from a lightly used secondary/tertiary level domain.

Multi-Use-IPs. By analyzing how IP addresses are assigned, and validating with legitimate data sources, it is possible to construct a file of ‘static’ IP addresses. For example, after initial collection, IP addresses can be noted on subsequent ‘opens’ or ‘clicks’ of e-mail communications. If the same IP address is commonly detected over a time window of weeks or months, the IP address is likely statically assigned. Another approach would correlate leads with the same IP gathered from lead sources determined to be legitimate. If the leads come from the same individual or household, the IP address is likely statically assigned. Finally, certain ISPs are known to statically assign IP addresses. Knowledge of network block ownership would identify the IPs managed by that Internet Service Provider (ISP). If multiple consumers appeared in the lead stream with the same IP address, it is likely fraudulent.

Some static addresses may correspond to a device owned by a given consumer. A check can be performed to see if static IPs within a source are appearing on leads belonging to different consumers/consumer households. A threshold, such as a percentage of static IP addresses that do not match the expected consumer, would allow for some error in the static IP identification process. A percentage above the threshold would be indicative of fraud.

IP Address Re-use. For non-static IP addresses, some level of IP address re-use by different end-users may be possible. However, a statistically significant higher-than-normal re-use of non-static IP addresses may indicate IP address copy-paste activity.

Multi-Use-Consumer. In credit card fraud detection, a metric called “velocity” is used to help determine if a set of transactions is fraudulent. A series of transactions taking place in a short window, in geographically dispersed places, has a high velocity and is more likely to be fraudulent. A consumer buying something in a store in LA, and moments later transacting business in Dallas, is a red flag. In a similar manner, a consumer completing a lead form with an IP geolocation in one area and moments later completing in another, is a sign of fraud. More generally, a legitimate lead source is not likely to have a large number of consumers with dramatically varying geolocation. In one variation, this check must be completed prior to deduplication.

Beyond detecting the same consumer record occurring with different IPs/IP geolocations, velocity can be used to assess the very appearance of consumers in one or more lead streams. For example, if a consumer record/e-mail address has not previously appeared in lead stream(s) and suddenly appears at a rate far in excess of an average consumer, it may indicate that the same record is being re-sold/re-cycled.

Valid Lead Collection URL. The URL where the lead was collected can be analyzed to check: 1) if it is a live address and 2) if it contains the expected lead form and privacy policy. If these checks fail, it can be indicative of fraud. Although it is possible that a URL is transient, invalid URLs above a threshold would be indicative of fraud.

Dedicated Lead Provisioning. In some instances, the marketer buys and pays a premium for an exclusive lead that is not supplied to others. Rogue lead suppliers may circumvent this by sharing the lead with other aggregators who also supply the marketer. They may also supply the data to other marketers in the same industry. Test identities can be created, comprised of the name/postal/dedicated telephone/dedicated e-mail address. The data would be submitted, manually or in an automated manner, at the URL provided for the lead form. The time of submission and IP address of submission is recorded.

If the collection process is working correctly, the lead should show-up in the vendor's lead stream. If it is a dedicated lead, it should not appear in another vendor's lead stream. By using the dedicated elements exclusively for the campaign, any e-mail or telephone calls received can be attributed to the lead submission. In the case of a dedicated lead, the only received messages should come from the authorized marketer. If additional contacts are received, it is a strong indicator of lead sharing.

The identity of the unauthorized marketers can, in some instances, also be determined. Automatic number identification (ANI) can be used to log the phone numbers of callers. A reverse append can be applied to the phone number to generate the name and address of the caller. As a further step, a voicemail box could be used to record any marketing message. Speech recognition software could be used to transcribe the call. In a similar manner, the e-mail address of the sender can be extracted and the domain name profiled (abc.com=ABC, Inc. 222 S. 68th St., Boulder, Colo. 80303). As a further step, the e-mail sig file could be mined to produce the name/title/company/address/phone of the sender. The full message text could also be archived.

URL Popularity. In some instances, a URL may be valid and contain the appropriate lead form but still not refer to the location where the lead was collected (or if it was validly collected at all). It may also be possible to leverage third party web traffic services such as Alexa and comScore to determine if the purported traffic to the URL correlates with the lead volume. If a URL never occurs in the web surfing activity of a panel of several million consumers, for example, it likely is not legitimate. This issue also can be addressed by having the lead source place a designated pixel-tracker in the URL that logs the clicks on it. If no clicks get logged on the URL then the URL likely isn't legitimate.

Time/Date Stamp of Opt-In/Lead Collection. The time date stamp field also carries information that may be used in fraud detection. Internet activity varies during the course of the day and night. For example, in paid search, it is commonly acknowledged that clicks increase throughout the day from morning hours to about 10 PM. According to NetElixir, online shopping purchases peak during the midday hours between 2 PM and 7 PM. Even these aggregate rules of thumb mask variations by category. Most searches online for products in the electronics category occur between 9 PM and midnight EST, with orders between 10 PM and 12 PM. Flowers are typically ordered between 5 PM and 7 PM. For women's apparel, search queries on average peak between 10 p.m. and 1 a.m. EST.

What these examples indicate is that characteristic patterns are likely also present in lead generation. Once the characteristic pattern is established, deviations from it can be quantified and used as a fraud indicator.

The characteristic pattern might be determined by profiling time/date stamps from known valid sources in the marketer's possession. It may also be possible to use services such as Alexa and comScore to obtain access times for the supplied URLs to establish a characteristic pattern.

Traffic Handling Capacity. From the leads dataset, the maximum burst-rate for hitting a particular URL can be calculated. Then the test would be to actually see if the site hosting the URL can actually handle the max burst of traffic that is reported in the dataset. If the site starts showing handling issues at a certain threshold percentage of the reported burst rate then it is likely that the data was faked.

Time/Date Stamp of Opens/Clicks. In some instances, fraud may be hidden by faking responses. For example, CPG marketers may send out e-mails to consumers in their database. Fraudulent e-mail accounts can easily be created in free e-mail services like gmail, Hotmail, or Yahoo mail and present in the database. Automated click bots, can then be programmed to access these accounts and open/click on received messages. In cases where no conversion (such as completing a purchase) is expected from the e-mail, it can be hard to determine if the response is valid or not.

Automated e-mail response bots can be detected by sending test e-mail messages in the middle of the night. A higher than normal night-time response of e-mails could indicate programmed bot response and therefore fraudulent activity.

By analyzing the response curve of e-mail campaigns, in aggregate and by source, anomalous activity may be detected. E-mail campaign response usually follows a noisy exponential decay, with some circadian variations. Deviations in the expected click rate response curve (number and timing of clicks) may be indicative of fraud. Examples would include a delayed response, a concordant spike of activity, or clicks/opens at anomalous day/times.

Automated click activity may also be detected with challenge/respond test, such as use of a CAPTCHA. In one approach, an e-mail is sent to select leads. A link is placed in the e-mail, and clickers are taken to a web page and prompted to enter a CAPTCHA to prove that they are a person and not a machine. The technique may make use of a sample of registrants from each source. Those sources with low ratios of successful CAPTCHA entry to clicks would be deemed more likely to be fraudulent.

Lead Source Overlap. Another common trick employed by rogue lead suppliers is to recycle leads, and sell them to multiple end clients or lead aggregators. A match score can be used to assess the overlap between lead sources/vendors. Cases of an exact match name/postal/e-mail/time date stamp/URL/IP would be strong evidence for lead recycling. But significant overlap in the contact information (name/postal address/telephone/e-mail) between lead sources would also indicate a higher propensity for fraud. By comparing suspected rogue leads suppliers of recycled leads against overlap with validated and good leads vendors over a period of time, it would be possible to detect and separate real rogue suppliers. An analysis of temporal overlap patterns can detect fraud. For example, if leads in source A subsequently appear in source B with a probability above an empirically-determined fraud threshold, B may be deemed a derivative source recycling leads.

Complaint/Opt-out Rates. Some level of complaints and opt-outs are to be expected in e-mail campaigns, even with pristine lead sources. However, a high level usually indicates something is amiss. Opt-out/complaint levels above a threshold could indicate that the source contains fraudulent leads.

Open/Click/Conversion Data. Lead sources which exhibit abnormally poor open/click rates are often fraudulent. In cases where lead conversion data are available (e.g. leads that subsequently purchase a promoted product/service), it can be a powerful detector of fraud. Sources that exhibit a statistically significant poor conversion rate are likely to be fraudulent.

Change of Address. With legitimately collected leads, the postal address for the consumer should be current. In conventionally practiced lead cleansing, National Change of Address (NCOA) processing is not applied since there should in theory be no moves applicable to the data.

In cases where leads are ‘recycled’, there should be a small fraction that have NCOA-updated address. In one embodiment, the number/percentage of updated records can be used as a fraud indicator. A fraudulent lead source may attempt to NCOA an old lead file, to obtain a current postal address. The source may then attempt to recycle a stale lead to the unwitting marketer. But if the IP field is not also updated to plausibly correspond to the new geo-location, the fraud can still be detected.

In a similar manner, a level of undeliverable e-mail addresses above a threshold would suggest that the data is old and possibly recycled.

Email-address construction. As an example, a higher than normal proportion of free e-mail services addresses could indicate abnormal datasets. As another example, a higher than normal proportion of e-mails with randomized name patterns or with numeric extensions (e.g., bert009@hotmail.com or jeff0345@gmail.com, etc.) could also indicate fraudulent creation of e-mail addresses.

Additional fields. Fraud detection may also be enhanced by requiring the submission of additional data fields with the leads or to enable third party collection of the additional data fields.

Browser Type. It is also possible to capture browser type. In general, installed software can be marked by monotonically increasing version numbers. So, if a number of consumers are seen sporting lower version numbers of their browser software, it may raise a red flag. Looking at aggregate market share of browser type, and sustained consumer preferences may also be a useful fraud flag.

Deterrent Measures. In cases where it can be practically implemented, pixel-tracking can be a useful tool to fight lead fraud. Pixel-tracking is one of the ways of ensuring that URL clicks gets registered and logged at third-party sites independently of the lead provider. Tracking Pixels within or at Form URLs can help ascertain whether the form filler actually opened the form and is so then when and with what browser etc. By embedding additional tracking pixels associated with lead form submission, completions can also be measured. It is also possible to capture the IP address and time/date stamp when opened, for comparison against the lead stream. If a significant percentage of the IPs and open times don't match the lead stream, fraud may be indicated.

Incorporation of Highly-Correlated Reference Databases. In most cases, it is not possible to directly compare a lead file against a ‘gold standard’ database to assess lead quality. However, in some cases, it is possible to compare lead files against third party databases with different, highly-correlated attributes to determine lead quality.

Expectant Mothers. A large market exists for expectant mother leads, since pregnancy is a precursor to many future purchases. Thus, identifying expectant mothers who have interest in learning more about a company's products or services has high economic value. Lead buyers have found that a substantial fraction of expectant mother leads are fraudulent.

As no comprehensive database/reference files of pregnancies exist, it is not possible to assess the validity of leads/lead sources directly. But commercial databases of new mothers do exist, which allows a time-lagged file of expectant mothers to be compared to a list of new mothers.

Our365 (www.our365) compiles a comprehensive file of new mothers based on in-hospital data collection. Pre-natal lead sources could be evaluated based on whether they eventually show up in the Our365 file. Lead source quality could be assessed by comparing pre-natal leads that are 9-12 months old to the current Our365 file. High quality lead sources should exhibit a high degree of overlap. Assuming that high quality sources remain so, new lead data can be sourced with confidence.

In some implementations, third party website traffic reports (e.g., Alexa, comScore, etc.) can be correlated with underlying lead volumes. In such cases, if a website URL has a characteristic geographic traffic distribution, the geographic distribution of the leads from that source should be very similar. For example, a local newspaper site would likely have a largely local audience. A large fraction of the leads generated from that site should come from the same city/state. Leads outside such geographical area (e.g., a lead generated by a Colorado newspaper from a New Hampshire resident, etc.) can be identified as an anomaly and potentially being fraudulent/inaccurate. Other geographic indicators such as census tract population data can be used to identify anomalies.

Other criteria can be used to indicate a questionable lead source. For example, a comparison of a marketer's existing customer database and the lead stream can be performed. If the Venn diagram is anomalous across sources, it can be used to indicate that a given source is fraudulent/inaccurate.

Lead price can also be used as an attribute. In many cases, the most legitimate lead sources tend to be the most expensive and so lower prices lead sources can be taken into account when making the fraudulent/inaccurate determination. Lastly, lead volume (and particular changes in volume) can be predictive. If a low volume lead supplier suddenly starts delivering much larger volumes, it may be a fraud indicator. Such attributes can also be utilized.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. In addition, unless otherwise stated, references to fraud should also be interpreted to include inaccurate submissions (which may or not be the result of fraudulent intent of the submitting entity). Other embodiments may be within the scope of the following claims.

What is claimed is:

1. A computer-implemented method comprising:
receiving data characterizing one or more leads;
determining, for each of the one or more leads, whether the lead is likely to be fraudulent and/or inaccurate using at least one predictive model, one or more of the utilized predictive models being trained using a plurality of historical leads with known fraud or accuracy data; and
providing data identifying and/or comprising one or more of (i) those leads that are determined to be fraudulent and/or inaccurate; and (ii) those leads that are determined not to be fraudulent and/or inaccurate.

2. A method as in claim 1, wherein providing data comprises at least one of storing data, loading data, displaying data, and transmitting data.

3. A method as in claim 1, wherein the predictive model is used to generate a score for each lead, wherein scores above a pre-determined threshold are determined to be likely fraudulent or inaccurate.

4. A method as in claim 1, wherein the leads comprise web-generated leads.

5. A method as in claim 4, wherein the web-generated leads comprise user-generated subscriptions or account registrations on a website.

6. A method as in claim 5, wherein the web-generated leads comprise user-generated requests for products and/or services.

7. A method as in claim 1, further comprising:
pre-processing at least one lead based on one or more pre-defined attributes of such at least one lead.

8. A method as in claim 7, further comprising:
determining that such pre-processed at least one lead is fraudulent and/or inaccurate, wherein the pre-processed at least one lead is identified to be fraudulent and/or inaccurate without using the predictive model.

9. A method as in claim 7, wherein the pre-processing comprises data cleansing.

10. A method as in claim 7, wherein the pre-processing comprises identifying duplicative leads.

11. A method as in claim 7, wherein the pre-processing comprises: attempting to verify one or more aspects of the filtered lead.

12. A method as in claim 1, further comprising:
post-processing at least one lead based on one or more pre-defined attributes of such at least one lead after the determination is made that the lead is likely to be fraudulent and/or inaccurate; and
wherein at least one lead is excluded from the provided data based on the post-processing.

13. A method as in claim 1, wherein the received data comprises attributes for each lead, and wherein the at least one predictive model assigns varying weights to the attributes of the leads.

14. A method as in claim 1, wherein the at least one predictive model comprises one or more of a scorecard model, a neural network, and a support vector machine.

15. A method as in claim 1, wherein the predictive model utilizes fraud indicators using attributes of the lead based on or comprising one or more of: routable Internet Protocol (IP) address, IP address geolocation, network owner of IP address, static IP address, frequency of use of IP address, number of leads corresponding to consumer, lead collection uniform resource locator (URL), dedicated lead provisioning, popularity of a referring URL, time stamp, date stamp, traffic handling capacity, lead source overlap, complaint rates, opt-out rates, change of address, e-mail address construction, presence of specified fields, browser type, highly correlated reference database entries, pixel-tracking results, geographic areas served by a corresponding lead source, census information, a price charged for the lead, and a volume or a change in volume of leads originating from the corresponding lead source.

16. A method as in claim 1, wherein the provided data identifies a particular lead as being fraudulent and/or inaccurate.

17. A method as in claim 1, wherein the provided data identifies a particular lead source as delivering fraudulent and/or inaccurate leads.

18. A non-transitory computer program product storing instructions, which when executed by one or more data processors of one or more computing systems, result in operations comprising:
receiving, by at least one data processor, data characterizing one or more leads;
determining, by at least one data processor for each of the one or more leads, whether the lead is likely to be fraudulent and/or inaccurate using at least one predictive model, one or more of the utilized predictive models being trained using a plurality of historical leads with known fraud or accuracy data; and
providing, by at least one data processor, data identifying and/or comprising one or more of (i)those leads that are determined to be fraudulent and/or inaccurate; and (ii) those leads that are determined not to be fraudulent and/or inaccurate.

19. A system comprising:
one or more data processors;
memory storing instructions, which when executed by the one or more data processors, result in operations comprising:
receiving, by at least one data processor, data characterizing one or more leads;
determining, by at least one data processor for each of the one or more leads, whether the lead is likely to be fraudulent and/or inaccurate using at least one predictive model, one or more of the utilized predictive models being trained using a plurality of historical leads with known fraud or accuracy data; and
providing, by at least one data processor, data identifying and/or comprising one or more of (i)those leads that are determined to be fraudulent and/or inaccurate; and (ii) those leads that are determined not to be fraudulent and/or inaccurate.

20. A computer-implemented method comprising:
receiving data characterizing one or more lead sources;
determining, for each of the one or more lead sources, whether the lead source is likely to be fraudulent and/or inaccurate using at least one predictive model, one or more of the utilized predictive models being trained using a plurality of historical leads with known fraud or accuracy data; and
providing data identifying and/or comprising one or more of (i) those lead sources that are determined to be fraudulent and/or inaccurate; and (ii) those lead sources that are determined not to be fraudulent and/or inaccurate.
